(19) United States
(12) Patent Application Publication
(10) Pub. No.: US 2005/0136854 A1
(43) Pub. Date: Jun. 23, 2005

(54) Transmitter

(75) Inventors: Taiji Akizuki, Sendai-shi (JP); Mitsuru Tanabe, Katano-shi (JP); Koichiro Tanaka, Takarazuka-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 11/001,809

(22) Filed: Dec. 1, 2004

(30) Foreign Application Priority Data
Dec. 4, 2003 (JP) 2003-405957

(51) Int. Cl. H04B 1/02; H05B 41/16; H05B 41/24

(52) U.S. Cl. 455/91; 375/295

(57) ABSTRACT

In a range (R3) in which an amplitude component voltage (VA) of a modulation wave signal from an OFDM signal generation unit corresponds to the average output power, an output voltage of a first voltage conversion unit (voltage applied to a base or a gate) is fixed, thus allowing the class AB operation of a high-frequency power amplifier. In a range (R4) in which VA is larger than that in R3, the output voltage of the first voltage conversion unit is increased, thus varying the operating class of the high-frequency power amplifier from class AB to class A. In a range (R2) in which VA is smaller than that in R3, the output voltage of the first voltage conversion unit is decreased, thus varying the operating class of the high-frequency power amplifier from class AB to class B. The efficiency at the time of the average power can be improved without degrading the maximum output power of the high-frequency power amplifier included in a transmitter.

### FIELD OF THE INVENTION

The present invention relates to a radio transmitter.

### BACKGROUND OF THE INVENTION

In general, in a modulation signal involving amplitude modulation, especially in multi-valued modulation such as QAM (Quadrature Amplitude Modulation), a linear operation is required for a high-frequency power amplifier that transmits an electric power to an antenna. For that reason, class A or class AB has been used as the operating class of the high-frequency power amplifier.

However, in accordance with the migration of communication to broadband, a communication technique such as OFDM (Orthogonal Frequency Division Multiplex) using a multicarrier has started to be used, and a conventional high-frequency power amplifier of the operational class such as class A and class AB has not been expected to provide high efficiency. That is, in the OFDM, a large electric power occurs instantaneously and completely at random due to the superposition of subcarriers, and a ratio between the average power and the instantaneous maximum power, or PAPR (Peak to Average Power Ratio) is large. Therefore, in order to allow for the linear amplification of a peak power that is relatively larger than the average power, it is necessary to maintain the operating class of the high-frequency power amplifier that enables the output of the maximum output power required. In the class A operation, the efficiency (the output high-frequency power/the power supplied with a DC current applied to a collector terminal or a drain terminal) becomes only 50% at the maximum. Especially in the case of the OFDM, since the PAPR is large, at the time other than the time for outputting the peak power, most of the power supplied with the DC current applied to the collector terminal or the drain terminal, which is given by multiplying a difference between a peak voltage for compensating for the peak power and an instantaneous voltage for compensating for the instantaneous power with a current, becomes heat to dissipate. As a result, the efficiency deteriorates considerably.

Therefore, in the case of a portable radio using a battery as a power source, for example, the continuous operable time becomes short, thus posing a practical problem.

In order to solve such a problem, a conventional EER (Envelope Elimination and Restoration) technique that is known as the Kahn's technique has been suggested, which is described in the specification of U.S. Pat. No. 6256482 B1, for example.

FIG. 5 is a circuit block diagram schematically showing the EER technique. In FIG. 5, an OFDM signal generated by an OFDM signal generation unit 501 is separated into a phase component and an amplitude component by a phase/amplitude separation unit 502. More specifically, vector waves of I and Q that are quadrature modulation components of the OFDM signal generated by the OFDM signal generation unit 501 are separated into their amplitude component √(I²+Q²) and their phase component tan⁻¹(Q/I). The phase component is upconverted by a quadrature modulator 504 and is input to a gate terminal of a high-frequency power amplifier (PA) 505 in the form of a high-frequency signal power (RFin). The amplitude component passes through a DC-DC converter 503 and is input to a source terminal of the high-frequency power amplifier 505 as a power-supply voltage (VDD).

As an example of the OFDM wave, in the case of IEEE802.11a that is the standard for a radio LAN with a frequency band of 5 GHz, about 7 dB is required for a back-off amount (the amount indicating what level should be reduced for operation from the saturation power). This corresponds to the average level of the high-frequency power equal to ⅕ of the peak power. That is, in the conventional example, when a power is supplied with a DC current applied to the drain terminal, the output high-frequency power becomes ⅕ of the maximum output power, so that the efficiency of only 10% can be realized, whereas a class A amplifier would realize the efficiency of 50% at the maximum. In this way, in order to use a high-frequency power amplifier of the operating class A or AB with high efficiency, it is desirable that a minimum power source voltage required for compensating for the output power is given successively to the high-frequency power amplifier so as to make the back-off amount, ideally, at 0 dB.

In order to solve this problem, according to the EER technique, in the high-frequency power amplifier 505, a modulated wave output from the quadrature modulator 504 is input as a phase component of a constant envelope amplitude to a gate of an input stage transistor, and the amplitude component is input through a drain terminal. The amplitude component and the phase component are multiplied with each other by the high-frequency power amplifier 505, which is output from the high-frequency power amplifier 505 as a modulated wave in which an OFDM signal (RFout) is quadrature-modulated. Such a configuration allows a drain voltage to be varied in synchronization with the output modulated wave and can reduce a difference between the peak voltage and the sequential voltage even in the case of the high-frequency power amplifier being class A, thus realizing an efficiency close to the maximum efficiency theoretically.

In the conventional EER technique, however, although the efficiency is improved by varying the voltage applied to the drain terminal or the collector terminal in synchronization with the amplitude component, a voltage applied to a base terminal or a gate terminal of the high-frequency power amplifier is made constant to fix the operating class of the high-frequency power amplifier. Therefore, the operating class of the high-frequency power amplifier should be set always at the operating class that enables the output of the required maximum output power, so that even when the average or lower power is output, the operating class of the base terminal or the gate terminal remains as the class A or the class AB close to the class A. As a result, considering an idle current applied to a collector terminal or a drain terminal, more than the necessary amount of the idle current should be fed when the average or lower power is output, which tends to degrade the efficiency in terms of the average power.

### SUMMARY OF THE INVENTION

Therefore, with the foregoing in mind, it is an object of the present invention to provide a transmitter having the EER technique whose efficiency at the time of the average power is improved without degrading the maximum output power by controlling a voltage input to a collector terminal or a drain terminal as well as a voltage input to a base terminal or a gate terminal in accordance with a power output from a high-frequency power amplifier so as to set the operating class of the high-frequency power amplifier variably.

In order to fulfill the above-stated object, a first transmitter according to the present invention includes: a modulation wave signal generation unit that generates a modulation wave signal; a phase/amplitude separation unit that separates the modulation wave signal generated by the modulation wave signal generation unit into a phase component and an amplitude component; a first voltage conversion unit that outputs a predetermined voltage with respect to the amplitude component and varies the output voltage from a minimum value to a maximum value in accordance with a variation of the amplitude component from a minimum value to a maximum value; a second voltage conversion unit that outputs a predetermined voltage with respect to the voltage output from the first voltage conversion unit; a frequency conversion unit that converts the phase component output from the phase/amplitude separation unit into a frequency to be transmitted; and a high-frequency power amplifier, in which an output signal of the frequency conversion unit is supplied to a high-frequency input terminal. The output voltage of the first voltage conversion unit is applied to a base terminal or a gate terminal, and the output voltage of the second voltage conversion unit is applied to a collector terminal or a drain terminal. The high-frequency power amplifier outputs a modulated wave in which an amplitude and a phase are multiplied with each other.

With this configuration, the first voltage conversion unit can be used for allowing the change of the voltage applied to the base terminal or the gate terminal in a monotonically increasing manner in accordance with the amplitude component output from the phase/amplitude separation unit. Therefore, the operating class can be set at class A around the maximum output power, whereas the operating class can be set closer to class B and class C around the average output power in which the efficiency should be improved. At this time, the gain would change in accordance with the change of the voltage applied to the base terminal or the gate terminal. However, the voltage applied to the collector terminal or the drain terminal can be adjusted by the second conversion unit so that the envelope of the output power coincides with a correct modulating signal that is equal to the modulation wave signal output from the modulation wave signal generation unit.

From the above, the voltage input to the collector terminal or the drain terminal as well as the voltage input to the base terminal or the gate terminal can be controlled in accordance with the power output from the high-frequency power amplifier and the operating class of the high-frequency power amplifier can be set variably. Thereby, a transmitter having the EER technique can be provided in which the efficiency at the time of the average power can be improved without degrading the maximum output power.

Furthermore, in order to fulfill the above-stated object, a second transmitter according to the present invention includes: a modulation wave signal generation unit that generates a modulation wave signal; an amplitude component generation unit that generates an amplitude component from the modulation wave signal generated by the modulation wave signal generation unit; a first voltage conversion unit that outputs a predetermined voltage with respect to the amplitude component and varies the output voltage from a minimum value to a maximum value in accordance with a variation of the amplitude component from a minimum value to a maximum value; a second voltage conversion unit that outputs a predetermined voltage with respect to the voltage output from the first voltage conversion unit; a frequency conversion unit that converts the modulation wave signal output from the modulation wave signal generation unit into a frequency to be transmitted; and a high-frequency power amplifier, in which an output signal of the frequency conversion unit is supplied to a high-frequency input terminal. The output voltage of the first voltage conversion unit is applied to a base terminal or a gate terminal, and the output voltage of the second voltage conversion unit is applied to a collector terminal or a drain terminal. The high-frequency power amplifier outputs a modulated wave in which an amplitude and a phase are multiplied with each other.

With this configuration, the first voltage conversion unit can be used for allowing the change of the voltage applied to the base terminal or the gate terminal in a monotonically increasing manner in accordance with the amplitude component output from the amplitude component generation unit. Therefore, the operating class can be set at class A around the maximum output power, whereas the operating class can be set closer to class B and class C around the average output power in which the efficiency should be improved. At this time, the gain would change in accordance with the change of the voltage applied to the base terminal or the gate terminal. However, the voltage applied to the collector terminal or the drain terminal can be adjusted by the second conversion unit so that the envelope of the output power agrees with a correct modulation signal that is equal to the modulation wave signal output from the modulation wave signal generation unit.

From the above, the voltage input to the collector terminal or the drain terminal as well as the voltage input to the base terminal or the gate terminal can be controlled in accordance with the power output from the high-frequency power amplifier and the operating class of the high-frequency power amplifier can be set variably. Thereby, a transmitter having the EER technique can be provided in which the efficiency at the time of the average power can be improved without degrading the maximum output power.

Furthermore, in the phase/amplitude separation unit in the first transmitter, filtering is conducted with respect to the phase component within a range that is permissible by the band of a digital/analogue converter and in such a degree that does not affect the modulation accuracy adversely. At this time, a partial decrease of the level of the phase component caused by the filtering generates a prominent deterioration of the modulation accuracy of the modulated wave in which the phase component is synthesized with the amplitude component at the output of the high-frequency power amplifier. As compared with the first transmitter, the phase/amplitude separation unit is not used in the second transmitter, and the modulation wave signal from the modulation wave signal generation unit is used as it is as a phase component. Therefore, the deterioration of the modulation accuracy, which inevitably occurs in the EER technique performed by separating the amplitude component and the phase component, can be avoided.

Furthermore, in the conventional EER technique, an input level that enables the sufficient saturation of the high-frequency power amplifier is applied even when a peak power is input. Therefore, if the isolation characteristics are not favorable at the time of the OFF state of the high-frequency power amplifier (amplitude component; 0 V), a power higher than an expected level will be output, which is then multiplied with the amplitude component, thus resulting in a failure of the restoration of the original modulation wave (the deterioration of the EVM performance is caused). On the other hand, according to the present configuration, since a modulated wave signal also is not input to the high-frequency power amplifier at the time of the OFF state of the high-frequency power amplifier (amplitude component; 0 V), a correct modulation wave can be restored irrespective of the isolation characteristics.

Furthermore, in the first and the second transmitters, the first voltage conversion unit judges in what voltage range among a plurality of predetermined voltage ranges the amplitude component is included, and selects to output a predetermined constant voltage as a voltage level to be output for each of the plurality of predetermined voltage ranges or to perform a predetermined voltage level conversion between input and output voltages and output the result.

With this configuration, within the voltage range that includes the voltage level of the amplitude component for outputting the average power, the output voltage from the first voltage conversion unit is made constant, whereby the operating class of the high-frequency power amplifier can be fixed irrespective of the voltage level of the amplitude component, thus minimizing the deterioration of the modulation accuracy and the output waveform due to the fluctuation of the operating class.

Moreover, the first and the second transmitters further may include a unit for designating an output power level for the modulation wave signal generation unit.

With this configuration, since a desired output power level can be designated for the modulation wave signal generation unit, the output power level can be set freely by setting an IQ level by the modulation wave signal generation unit.

### BRIEF DESCRIPTION OF THE DRAWINGS

FIG. 1 is a circuit block diagram showing one exemplary configuration of a transmitter according to Embodiment 1 of the present invention.

FIG. 2 is a circuit block diagram showing one exemplary configuration of a transmitter according to Embodiment 2 of the present invention.

FIG. 3A is a graph showing the characteristics of the voltage Vb applied to a base or a gate versus the amplitude component voltage VA in a transmitter according to Embodiment 3 of the present invention.

FIG. 3B is a graph showing the characteristics of the output power Pout versus the amplitude component voltage VA in the transmitter according to Embodiment 3 of the present invention.

FIG. 3C is a graph showing the characteristics of the power supply efficiency η versus the amplitude component voltage VA in the transmitter according to Embodiment 3 of the present invention.

FIG. 4A is a graph showing the characteristics of the voltage Vb applied to a base or a gate versus the amplitude component voltage VA in a conventional transmitter.

FIG. 4B is a graph showing the characteristics of the output power Pout versus the amplitude component voltage VA in the conventional transmitter.

FIG. 4C is a graph showing the characteristics of the power supply efficiency η versus the amplitude component voltage VA in the conventional transmitter.

FIG. 5 is a circuit block diagram showing an exemplary configuration of the conventional transmitter.

### DETAILED OF THE PREFERRED EMBODIMENTS

The following describes preferred embodiments of the present invention, with reference to the drawings. Herein, the following embodiments assume that a modulation wave is based on the OFDM. A system employing the OFDM includes, for example, a radio LAN system complying with the IEEE802.11a standard. In the radio LAN system, the modulation of 64 QAM is applied to each of the fifty-two quadrature subcarriers, which then are summed so as to obtain a modulated wave signal. The fifty-two subcarriers are separated from each other by 312.5 kHz, thus occupying 16.25 MHz (=52×312.5).

### Embodiment 1

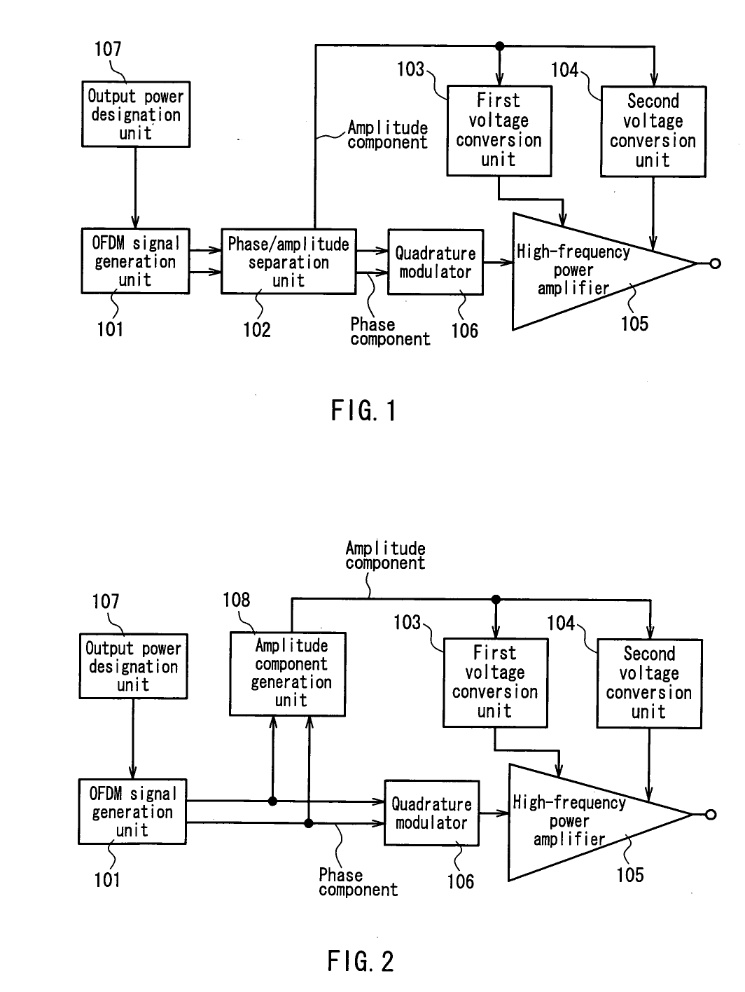

FIG. 1 is a circuit block diagram showing one exemplary configuration of a transmitter that realizes the EER technique according to Embodiment 1 of the present invention. This transmitter, as shown in FIG. 1, includes: an OFDM signal generation unit 101 as a modulation wave signal generation unit: a phase/amplitude separation unit 102; a first voltage conversion unit 103 and a second voltage conversion unit 104 each receiving an amplitude component from the phase/amplitude separation unit 102 as an input voltage and varying an output voltage level in accordance with a voltage level of the amplitude component; a high-frequency power amplifier 105 having a base terminal or a gate terminal to which an output voltage of the first voltage conversion unit 103 is applied and a collector terminal or a drain terminal to which an output voltage of the second voltage conversion unit 104 is applied; a quadrature modulator 106 as a frequency conversion unit; and an output power designation unit 107 that designates an output power level for the OFDM signal generation unit 101.

The following describes an operation of the thus configured transmitter.

In FIG. 1, the OFDM signal is generated by the OFDM signal generation unit 101 and is separated into a phase component and an amplitude component by the phase/amplitude separation unit 102.

The separated amplitude component is supplied to each of the first voltage conversion unit 103 and the second voltage conversion unit 104.

The first voltage conversion unit 103 outputs an output voltage level that is determined beforehand depending on a voltage level of the input amplitude component and supplies a voltage and a current that are capable of driving the high-frequency power amplifier 105 when connecting with the base terminal or the gate terminal of the high-frequency power amplifier 105.

Furthermore, the first voltage conversion unit 103 carries out voltage level conversion between input/output voltages so as to allow the output voltage to be varied from a minimum value to a maximum value in accordance with the variation of the input amplitude component from a minimum value to a maximum value.

Similarly to the first voltage conversion unit 103, the second voltage conversion unit 104 allows the output of an output voltage level that is determined beforehand with respect to the output voltage variation of the first voltage conversion unit 103 by setting the input amplitude component as a reference value, and supplies a voltage and a current that are capable of driving the high-frequency power amplifier 105 when connecting with the collector terminal or the drain terminal of the high-frequency power amplifier 105.

In addition, although the amplitude component is used as the reference value for the second voltage conversion unit 104 in this configuration, the output voltage of the voltage conversion unit 103 is provided directly as the reference value, so as to further enhance the accuracy of the voltage level conversion between the input/output voltages.

As a result, the first voltage conversion unit 103 enables the variation of the output voltage to be applied to the base terminal or the gate terminal with respect to the voltage level of the input amplitude component, thus making the operating class of the high-frequency power amplifier 105 variable in accordance with the voltage level of the amplitude component.

Furthermore, even in the case where the first voltage conversion unit 103 changes the operating class and the gain of the high-frequency power amplifier 105 fluctuates, the second voltage conversion unit 104 converts the voltage level of the amplitude component between the input/output voltages so that the envelope of the output power agrees with a correct modulation signal that is equal to the modulation wave signal output from the OFDM signal generation unit 101, and the resultant amplitude component is applied to the collector terminal or the drain terminal. Thereby, the output power of the high-frequency power amplifier 105 can be kept in an output power range that is linear and is free from distortion.

Furthermore, the amplitude component is input from the second voltage conversion unit 104 to the collector terminal or the drain terminal of the high-frequency power amplifier 105, and the phase component is converted into the frequency to be output by the quadrature modulator 106 and is applied to the high-frequency power amplifier 105, whereby the high-frequency power amplifier 105 can output a modulated signal in which the phase and the amplitude are multiplied with each other.

Furthermore, the output power designation unit 107 may accept a designation concerning the transmitting power control from a MAC (Media Access Control) etc. so as to control the power to be transmitted.

As stated above, according to the present embodiment, the voltage input to the collector terminal or the drain terminal as well as the voltage input to the base terminal or the gate terminal can be controlled in accordance with the power output from the high-frequency power amplifier 105 and therefore the operating class of the high-frequency power amplifier 105 can be set variably. Thereby, a transmitter having the EER technique can be provided in which the efficiency at the time of the average power can be improved without degrading the maximum output power.

Furthermore, even when the operating class of the high-frequency power amplifier 105 is changed from class A to class B and class C and the gain of the high-frequency power amplifier 105 fluctuates depending on the operating class used, the amplitude component applied to the collector terminal or the drain terminal is varied so that the envelope of the output power agrees with the correct modulation signal that is equal to the modulation wave signal output from the OFDM signal generation unit 101, whereby a linear output power range that is used in the high-frequency power amplifier 105 can be increased.

Furthermore, in the case where the amplitude component from the phase/amplitude separation unit 102 is a voltage around 0 V, the isolation characteristics of the high-frequency power amplifier can be improved by changing the operating class of the high-frequency power amplifier 105 to class B, class C and the like.

Furthermore, the output voltages of the first voltage conversion unit 103 and the second voltage conversion unit 104 are adjusted so that the output power of the high-frequency power amplifier 105 can keep the linearity in accordance with the amplitude component from the phase/amplitude separation unit 102, thus enabling the correction of a distortion component of the output power of the high-frequency power amplifier 105.

Furthermore, the voltage input to the collector terminal or the drain terminal is controlled so as not to be lower than the voltage input to the base terminal or the gate terminal, whereby the destruction resistance of the high-frequency power amplifier 105 can be improved.

Furthermore, since the output power designation unit 107 enables the designation of a desired output power level for the OFDM signal generation unit 101, the output power level can be set freely by setting an IQ signal level that is an input signal of the OFDM signal generation unit 101.

### Embodiment 2

FIG. 2 is a circuit block diagram showing one exemplary configuration of a transmitter that realizes the EER technique according to Embodiment 2 of the present invention. Note here that in FIG. 2 the same reference numerals are assigned to the same elements as in Embodiment 1 and their detailed explanations are omitted.

The transmitter of the present embodiment, as shown in FIG. 2, is different from Embodiment 1 in that a modulation wave signal output from an OFDM signal generation unit 101 is supplied directly to a quadrature modulator 106 and an amplitude component generation unit 108 is used for extracting an amplitude component from the modulation wave signal so as to omit the phase/amplitude separation unit 102.

According to this configuration, instead of the phase component, the modulation wave signal is used as it is as an input signal of the quadrature modulator 106. Therefore, the deterioration of a modulation accuracy (Error Vector Magnitude: EVM), which inevitably occurs in the EER technique performed by separating the amplitude component and the phase modulated component, can be avoided. That is, in the case of the phase component used, filtering is conducted with respect to the phase component within a range that is permissible by the band of a digital/analogue converter and in such a degree that does not affect the EVM adversely. At this time, a partial decrease of the amplitude of the phase component caused by the filtering generates a prominent deterioration of the EVM when the phase component is synthesized with the amplitude component at the output of the high-frequency power amplifier. In addition, the required bandwidth of the modulated wave signal is smaller than the phase component separated from the modulation wave signal by about ⅙, bandwidths of the digital/analogue converter and an anti alias filter for suppressing a spurious component occurring due to the digital/analogue conversion can be narrowed, and therefore this configuration is advantageous for lowering the power consumption of the digital/analogue converter and reducing the cost for the circuit at the later stage.

Furthermore, in the conventional EER technique, an input level that enables the sufficient saturation of the high-frequency power amplifier is applied even when a peak power is input. Therefore, if the isolation characteristics are not favorable at the time of the OFF state of the high-frequency power amplifier (amplitude component; 0 V), the multiplying with the amplitude component cannot be performed accurately, resulting in a failure of the restoration of the original modulation wave (the deterioration of the EVM performance is caused). On the other hand, according to the present configuration, since a modulated wave signal also is not input to the high-frequency power amplifier at the time of the OFF state of the high-frequency power amplifier (amplitude component; 0 V), a correct modulation wave can be restored irrespective of the isolation characteristics.

Note here that although the modulation wave signal is converted into the modulated wave using the quadrature modulator 106 in this configuration, in the case where the OFDM signal generation unit 101 outputs the modulated wave, the quadrature modulator 106 becomes unnecessary. In this case, the amplitude component generation unit 108 detects the amplitude of the modulated wave and extracts the amplitude component.

As stated above, according to the present embodiment, the voltage input to the collector terminal or the drain terminal as well as the voltage input to the base terminal or the gate terminal can be controlled in accordance with the power output from the high-frequency power amplifier and the operating class of the high-frequency power amplifier can be set variably. Thereby, a transmitter having the EER technique can be provided in which the efficiency at the time of the average power can be improved without degrading the maximum output power.

Furthermore, instead of the use of the phase/amplitude separation unit of Embodiment 1, the modulation wave signal from the modulation wave signal generation unit is used as it is as the phase component. Therefore, the deterioration of a modulation accuracy, which inevitably occurs in the EER technique performed by separating the amplitude component and the phase component, can be avoided.

Furthermore, since a modulated wave signal also is not input to the high-frequency power amplifier at the time of the OFF state of the high-frequency power amplifier (amplitude component; 0 V), there is no output from the high-frequency power amplifier and a correct modulation wave signal can be restored irrespective of the isolation characteristics.

Furthermore, the required bandwidth of the modulation wave signal is smaller than the phase component separated from the modulation wave signal by about ⅙. Bandwidths of a digital/analogue converter and an anti alias filter for suppressing a spurious component occurring due to the digital/analogue conversion can be narrowed. Therefore this configuration can realize the lowering of the power consumption of the digital/analogue converter, the miniaturization of an inductor used for a filter and the reduction of the cost.

Furthermore, since the output power designation unit 107 enables the designation of a desired output power level for the OFDM signal generation unit 101, the output power level can be set freely by setting an IQ signal level that is an input signal of the OFDM signal generation unit 101.

### Embodiment 3

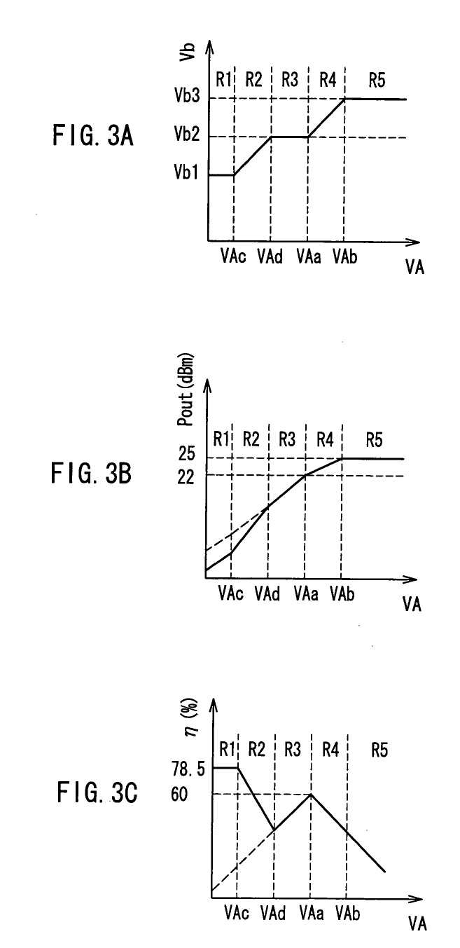

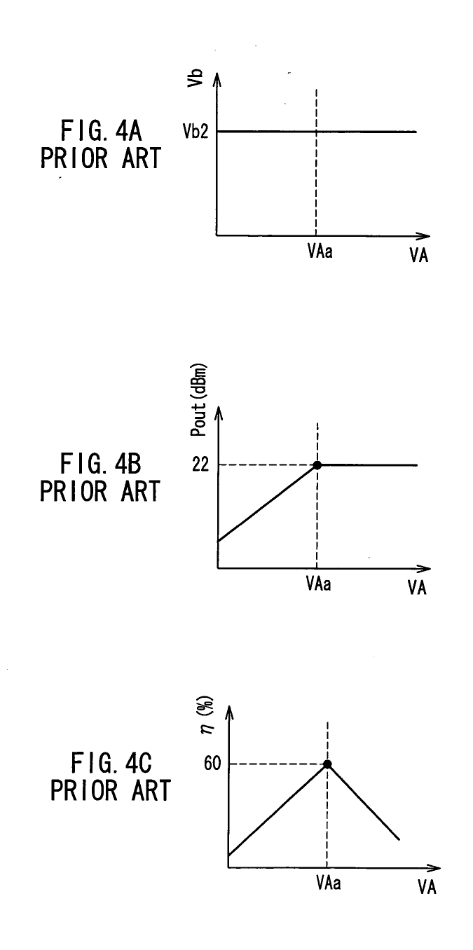

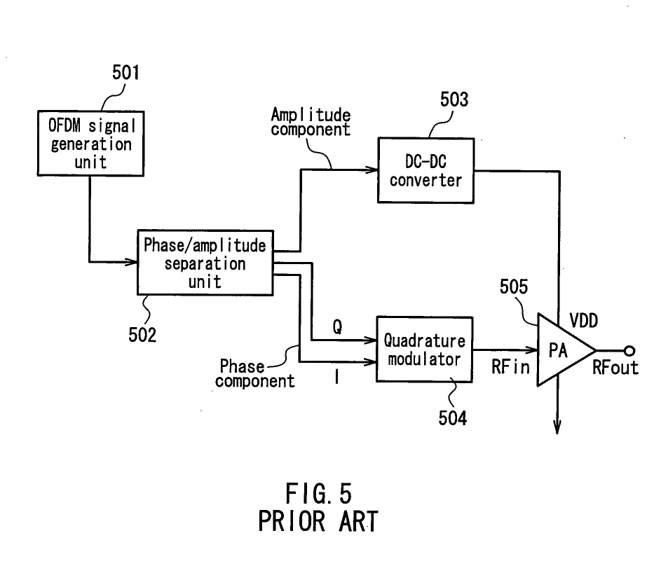

FIG. 3A, FIG. 3B and FIG. 3C are graphs for explaining a specific exemplary operation of a first voltage conversion unit 103 (FIG. 1 and FIG. 2) of a transmitter according to Embodiment 3 of the present invention. FIG. 4A, FIG. 4B and FIG. 4C are graphs for explaining an operation of a conventional transmitter. In the following description, an operational condition of the conventional transmitter is explained first, and then the operation of the transmitter according to the present embodiment is explained.

The efficiencies of a high-frequency power amplifier differ as follows depending on the operating classes: under the ideal conditions, the maximum efficiency of the class A operation is 50%, the maximum efficiency of the class B operation is 78.5% and the gain of the class B operation is lower than that of the class A operation by 6 dB. Therefore, consideration is given usually to both characteristics of the efficiency and the gain, and the class AB is selected as the operating class for many high-frequency power amplifiers.

In this embodiment, for the explanation of a general configuration, a high-frequency power amplifier having the following exemplary configuration is described: the conventional EER type high-frequency power amplifier is used at a saturation region; in the case where the setting of the operating class is fixed to the class AB as shown in FIG. 4A (voltage Vb applied to a base terminal or a gate terminal is fixed as Vb2), the characteristics of the high-frequency power amplifier are such that when the amplitude component voltage VA is VAa, the output power Pout becomes the maximum saturation output power as shown in FIG. 4B, where the maximum saturation output power at this time is 22 dBm and when the amplitude component voltage VA is VAa, the power supply efficiency Ti becomes the maximum efficiency of 60% as shown in FIG. 4C and the gain becomes smaller than that of the operating class A by 3 dB.

In the first voltage conversion unit 103 shown in FIG. 1 or FIG. 2, the threshold values of the amplitude component voltage VA may be set as follows as shown in FIG. 3A, for example: when the amplitude component voltage VA is VAc, the voltage Vb that is applied to the base terminal or the gate terminal becomes Vb1, resulting in the class B operation. When the amplitude component voltage VA is VAb, the voltage Vb that is applied to the base terminal or the gate terminal becomes Vb3, resulting in the class A operation. When the amplitude component voltage VA is VAa, the class AB operation in which the voltage Vb applied to the base terminal or the gate terminal becomes Vb2 is kept from VAd to VAa.

At this time, a range controlled by the first voltage conversion unit 103 is divided into the following five control ranges:
Region R1: class B operation when the amplitude component voltage is VAc or less;
Region R2: class AB operation close to class B operation when the amplitude component voltage is from VAc to VAd;
Region R3: class AB operation when the amplitude component voltage is from VAd to VAa;
Region R4: class AB operation close to class A operation when the amplitude component voltage is from VAa to VAb; and
Region R5: class A operation when the amplitude component voltage is VAb or more.

The first voltage conversion unit 103 is controlled within the range shown in FIG. 3A, whereby the operating class of the high-frequency power amplifier 105 can be varied from class AB to class A by varying the voltage Vb applied to the base terminal or the gate terminal from Vb2 to Vb3 in Region R4 as shown in FIG. 3B. Therefore, in the case of this specific example, the maximum output power can be increased from 22 dBm by 3 dB to be 25 dBm.

Furthermore, the first voltage conversion unit 103 is controlled within the range shown in FIG. 3A, whereby the operating class of the high-frequency power amplifier 105 can be varied from class AB to class B by varying the voltage Vb applied to the base terminal or the gate terminal from Vb2 to Vb1 in Region R2 as shown in FIG. 3C. Therefore, in the case of this specific example, the maximum efficiency in Region R1 can be improved to 78.5% of the class B operation ideally, so that the efficiency of a modulated signal output from the high-frequency power amplifier 105 can be improved.

As stated above, according to the present embodiment, the efficiency at the time of the average power can be improved without degrading the maximum output power. Furthermore, within the voltage range that includes the voltage level of the amplitude component for outputting the average power, the output voltage from the first voltage conversion unit 103 is made constant, whereby the operating class of the high-frequency power amplifier 105 can be fixed irrespective of the voltage level of the amplitude component, thus minimizing the deterioration of the modulation accuracy and the output waveform due to the fluctuation of the operating class.

As stated above, the transmitter according to the present invention has the advantage of allowing the improvement of the efficiency at the time of the average power without degrading the maximum output power, and therefore the transmitter is applicable to a portable type radio or the like that is equipped with a high-frequency power amplifier that outputs a modulated wave by multiplying a phase component and an amplitude component and adopts various modulation techniques.

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A transmitter, comprising:
a modulation wave signal generation unit that generates a modulation wave signal;
a phase/amplitude separation unit that separates the modulation wave signal generated by the modulation wave signal generation unit into a phase component and an amplitude component;
a first voltage conversion unit that outputs a predetermined voltage with respect to the amplitude component and varies the output voltage from a minimum value to a maximum value in accordance with a variation of the amplitude component from a minimum value to a maximum value;
a second voltage conversion unit that outputs a predetermined voltage with respect to the voltage output from the first voltage conversion unit;
a frequency conversion unit that converts the phase component output from the phase/amplitude separation unit into a frequency to be transmitted; and
a high-frequency power amplifier, in which an output signal of the frequency conversion unit is supplied to a high-frequency input terminal, the output voltage of the first voltage conversion unit is applied to a base terminal or a gate terminal, and the output voltage of the second voltage conversion unit is applied to a collector terminal or a drain terminal, the high-frequency power amplifier outputting a modulated wave in which an amplitude and a phase are multiplied with each other.

2. The transmitter according to claim 1, wherein the first voltage conversion unit judges in what voltage range among a plurality of predetermined voltage ranges the amplitude component is included, and selects to output a predetermined constant voltage as a voltage level to be output for each of the plurality of predetermined voltage ranges or to perform a predetermined voltage level conversion between input and output voltages and output the result.

3. The transmitter according to claim 1, further comprising: a unit for designating an output power level for the modulation wave signal generation unit.

4. A transmitter, comprising:
a modulation wave signal generation unit that generates a modulation wave signal;
an amplitude component generation unit that generates an amplitude component from the modulation wave signal generated by the modulation wave signal generation unit;
a first voltage conversion unit that outputs a predetermined voltage with respect to the amplitude component and varies the output voltage from a minimum value to a maximum value in accordance with a variation of the amplitude component from a minimum value to a maximum value;
a second voltage conversion unit that outputs a predetermined voltage with respect to the voltage output from the first voltage conversion unit;
a frequency conversion unit that converts the modulation wave signal output from the modulation wave signal generation unit into a frequency to be transmitted; and
a high-frequency power amplifier, in which an output signal of the frequency conversion unit is supplied to a high-frequency input terminal, the output voltage of the first voltage conversion unit is applied to a base terminal or a gate terminal, and the output voltage of the second voltage conversion unit is applied to a collector terminal or a drain terminal, the high-frequency power amplifier outputting a modulated wave in which an amplitude and a phase are multiplied with each other.

5. The transmitter according to claim 4, wherein the first voltage conversion unit judges in what voltage range among a plurality of predetermined voltage ranges the amplitude component is included, and selects to output a predetermined constant voltage as a voltage level to be output for each of the plurality of predetermined voltage ranges or to perform a predetermined voltage level conversion between input and output voltages and output the result.

6. The transmitter according to claim 4, further comprising: a unit for designating an output power level for the modulation wave signal generation unit.
